(19) United States
(12) Patent Application Publication
(10) Pub. No.: US 2020/0119534 A1
(43) Pub. Date: Apr. 16, 2020

(54) FIRE-PROOFING INSERT FOR ELECTRIC MOUNTING BOXES

(71) Applicant: Hilti Aktiengesellschaft, Schaan (LI)

(72) Inventors: Herbert Münzenberger, Wiesbaden (DE); Michael Drexl, Schondorf (DE)

(73) Assignee: Hilti Aktiengesellschaft, Schaan (LI)

(21) Appl. No.: 16/472,042

(22) PCT Filed: Feb. 7, 2018
(86) PCT No.: PCT/EP2018/053006

§ 371 Date: Jun. 20, 2019

(30) Foreign Application Priority Data
Feb. 22, 2017 (EP) 17157386.8

(51) Int. Cl. H02G 3/08

(52) U.S. Cl. CPC H02G 3/088

(57) ABSTRACT

An insert for fireproofing at least one electric mounting box contains a substrate material and an intumescent layer, both the substrate material and the intumescent layer being able to undergo plastic deformation.

The invention relates to an insert as fire protection of electric mounting boxes, having a carrier material and at least one intumescent layer, as well as to a method for manufacturing such an insert.

Drywalls are being used increasingly more frequently for the interior construction of buildings. Fire-protection walls for prevention of propagation of a fire are also being manufactured increasingly more often in drywall construction. The electric mounting boxes used for drywalls are particularly critical for this purpose.

The wall openings needed for installation of electric mounting boxes represent a weak point in the drywalls, via which a fire can easily spread into adjoining rooms. For regulatory approval tests, the electric mounting boxes are plastered into the drywalls. Hereby a regulatory approval test can be positively influenced. In practice, this is usually not possible, since the drywalls and the electric mounting boxes are usually installed at different times by different tradesmen.

However, no standardized fire-protection system for such electric mounting boxes has yet been introduced in Europe. The reason for this is in particular the diversity existing in Europe concerning the various electric mounting boxes having different dimensions and configurations. For example, round or polygonal electric mounting boxes are used depending on the specific country. Products currently used in Europe, such as the “switch box insert” and “switch box cover” of the Tenmat Co. are designed only for one type of electric mounting box and are not usable system-wide.

The object of the invention consists in improving the fire protection of different electric mounting boxes with little expense.

This object is solved by means of the respective subject matter of the independent claims. Advantageous configurations of the invention are subject matter of respective dependent claims.

According to one aspect of the invention, an insert is provided as fire protection of at least one electric mounting box having a carrier material and at least one intumescent layer, wherein the carrier material and the intumescent layer are plastically deformable. The invention is based on the underlying idea of “toughening” an electric mounting box by equipping it with an insert that has the desired fire-protection properties due to the intumescent material. This insert may either be supplied in different dimensions, wherein it has been recognized in this connection that the number of different dimensions used in practice is limited. Therefore the entire market may be covered with a quite small number of different dimensions. Alternatively, the insert may be cut to the respectively needed dimensions on the spot, so that only a “blank” is needed that is then customized in the desired manner.

The insert is suitable in particular for electric mounting boxes to be installed in drywalls. Drywalls are also being used increasingly more frequently as firewalls in the interior construction of public buildings, schools, hospitals and office premises. Due to their particular properties, their occasionally special areas of use and their nature, drywalls impose a particular requirement on the electric mounting boxes used and on their fire-protection system. The insert meets these special requirements and is also usable for insertion in electric mounting boxes suitable for installation in drywalls. The insert is preferably designed in the form of a mat having a definite thickness. The insert has a carrier material, which is suitable for receiving at least one intumescent layer. The carrier material may consist, for example, of a metal or a plastic. The at least one intumescent layer may be applied as a coating on the carrier material. Alternatively or additionally, the intumescent layer may be adhesively bonded or rolled onto the carrier material. The carrier material may also surround the intumescent layer in form-fitting or frictional manner or may form a sandwich structure with the intumescent layer. The intumescent layer is designed in such a way that, upon the action of heat, optimally in a fire situation, it increases in volume and decreases in density, or releases a coolant such as water vapor, for example. Hereby the components within the electric mounting box are protected by the intumescent layer from the action of heat, and spreading of a fire through the electric mounting box is suppressed. Due to such an insert or inlay, electric mounting boxes having different country-specific dimensions and configurations may be designed with a fireproof protection prior to inclusion of installation components such as, for example, electrical lines, switches and sockets. By virtue of the flexible adaptation properties, the insert may therefore be used regardless of the type of electric mounting box. The insert is configured such that it becomes adapted by plastic deformation, for example by kinking or warping, to the different electric mounting boxes, and is able to line the inner surface of an electric mounting box. In this connection, an insert adapted to an electric mounting box may permanently assume the shape assumed after a defined time period or may remain permanently plastically deformable. The insert may preferably be pre-customized for a particular electric mounting box or, as a mat or product sold by the meter, may be capable of being subsequently cut to size or customized by a user.

Preferably, the carrier material consists of metal, so that plastic deformability may be united with high temperature resistance.

According to one exemplary embodiment, the carrier material of the insert is a metal foil or a metal sheet. The plastic deformability of the insert may be influenced by the choice of the type and thickness of the metal used as carrier material. In this respect, the use of a thin metal foil as the carrier material may offer a high flexibility of the insert. In contrast, depending on thickness of the metal sheet, the use of a metal sheet may reduce the deformability, but nevertheless develop a certain clamping effect in the electric mounting box and offer additional stability in itself and for the electric mounting box. Thus the insert may be clamped frictionally, for example, with the electric mounting box. Since electric mounting boxes usually consist of a plastic, the metallic carrier material may reinforce the electric mounting box mechanically in the fire situation and reduce or prevent deformation of the electric mounting box due to the action of heat.

According to a further exemplary embodiment, the carrier material is a metal mesh or metal fabric. For the finished insert, this permits greater stability compared with the metal foil and greater flexibility as well as lighter weight compared with the metal sheet. For example, an expanded-metal mesh may be used as the metal mesh. In the case of use of a mesh or fabric, the intumescent layer is able to penetrate through the openings or weave of the carrier material and develop a stable bond while being applied on the carrier material.

According to a further exemplary embodiment, the intumescent layer can be applied on the carrier material on at least one side, or the carrier material can be enclosed by the intumescent layer, at least in regions. In this connection, the intumescent layer may be rolled, sprayed, cast or painted onto the carrier material on one or both sides. Hereby such an insert may be manufactured in various ways. Alternatively, the carrier material could be equipped with the intumescent layer by an impregnation and subsequent drying process. In this way, a complete and secure enclosure of the carrier layer by the intumescent layer is ensured.

According to a further exemplary embodiment, the insert has a maximum thickness of less than 4 mm. Hereby it is ensured that the insert occupies such a small space in all electric mounting boxes currently available on the market that switch and socket elements can still be installed without problems in the electric mounting boxes. The installation space for the switch and socket elements is therefore reduced only slightly by the use of the insert, which is reliably capable of fire protection. Thus the type of switch elements, socket elements and electric mounting box is immaterial. The insert may be used for all electric mounting boxes and switch or socket systems available in Europe and is adaptable individually to the respective shape of the electric mounting boxes.

According to a preferred embodiment, the insert has at least two arms situated opposite one another, so that it can be introduced interlockingly in rectangularly shaped or round electric mounting boxes. The arms may be braced on oppositely situated walls of the electric mounting box, wherein the insert, by virtue of the plastic deformability, may be adapted without problems to individual shapes of various electric mounting boxes, so that it lines the electric mounting box in precisely fitting manner. Possible cavities between the insert and the electric mounting box may be prevented in this way, so that the fire protection generated by the insert rests directly on the inner surface of the electric mounting box.

According to a further exemplary embodiment, the length of the arms is greater than the depth of the electric mounting box. This ensures that, in the condition inserted in the electric mounting box, the insert projects at least in regions beyond one rim of a wall of the electric mounting box. By means of the installation components such as switches or sockets, it is possible to fix the insert in the electric mounting box. In the process, the insert may be clamped for fixation between the electric mounting box and the installation components. Alternatively, the insert could also be adhesively bonded into the electric mounting box or fixed by common screws together with installation components in the electric mounting box. The projection of the insert beyond the rim of the electric mounting box guarantees that fire protection is ensured for the entire inner surface of the electric mounting box and also that the rim regions of the electric mounting box are protected from the action of fire. In particular, a closure of the electric mounting box or a mounted socket or a switch is able to clamp the projecting regions of the insert between itself and a wall or a rim of the electric mounting box and to achieve an optimum sealing effect.

According to a further aspect of the invention, a method for manufacturing an insert is provided. For this purpose, a plastically deformable carrier material is supplied and at least one intumescent layer is applied on the supplied carrier material and then solidified, especially by drying or curing.

The intumescent layer may be sprayed, cast, rolled or painted onto the carrier material on one or both sides. Alternatively, the carrier material may also be immersed in a molten or liquid intumescent material and completely enclosed thereby. After application, preferably a drying or curing process takes place. For example, an intumescent layer may be applied on the carrier material in a two-component or one-component injection-molding process. For this purpose, an intumescent thermoplastic may be used. Alternatively, a reaction injection molding (RIM) process having a multi-component intumescent reaction compound may be used for application of the at least one intumescent layer on the carrier material. Due to the plastically deformable carrier material, an insert manufactured in this way is likewise plastically deformable. Thus the insert may be adapted to an electric mounting box on the spot or in advance. For this purpose, the insert may be cut and bent in order to adapt the insert to components within the electric mounting box and to the internal geometry of the electric mounting box.

According to a further exemplary embodiment, the carrier material is supplied in pre-customized form or the insert is subsequently customized. In this connection, the preferred shape may be selected during the manufacturing process by cutting out, perforating or stamping the carrier material. If the preferred shape is the final shape of the finished insert, it is immediately ready for use. Alternatively, several inserts could be molded cohesively in the set and joined to one another via a perforation, for example. A consumer could then separate each one of the inserts from the others as needed. Furthermore, the insert could be manufactured as a flat mat or as a product sold by the meter in the form of a roll, so that an insert may be cut individually to size out of the flat mat. In the process, the shape of the respective insert may be predetermined, for example by a perforation or an imprint or, depending on requirement, may be decided individually, free of preconditions.

According to a further aspect of the invention, an electric mounting box having a plastically deformable insert is provided, wherein the insert is adaptable to an inner region of the electric mounting box. Due to the plastically deformable insert, this may be adapted regardless of any internal geometry of the electric mounting box in such a way that no cavities are formed between the insert and a wall of the electric mounting box. The insert may always be placed in precisely fitting manner in the electric mounting box. Excess material of the insert may either be left in place for the purpose of sealing the electric mounting box or may be cut away.

Preferred exemplary embodiments of the invention will be explained in more detail hereinafter on the basis of greatly simplified schematic diagrams. Herein,

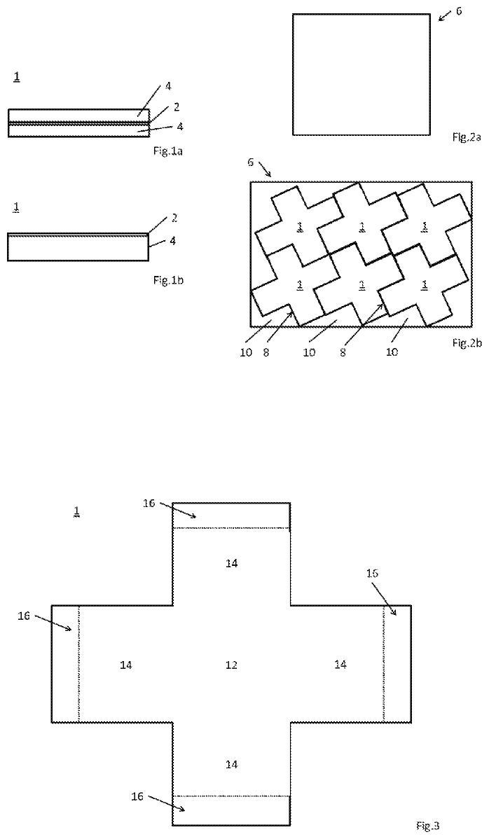

FIG. 1a shows a schematic cross section of an insert according to a first exemplary embodiment,

FIG. 1b shows a schematic cross section of an insert according to a second exemplary embodiment;

FIG. 2a shows a schematic overhead view of a mat for cutting out at least one insert according to a first embodiment,

FIG. 2b shows a schematic overhead view of a mat having a multiplicity of inserts according to a second embodiment,

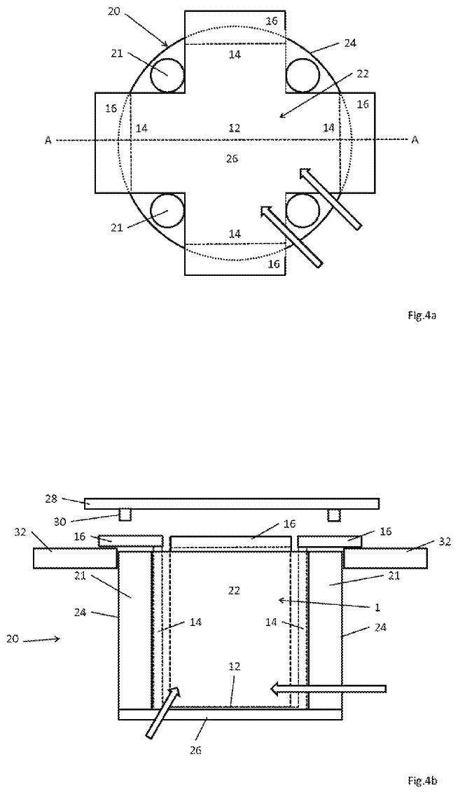

FIG. 3 shows a schematic overhead view of an insert according to the second embodiment,

FIG. 4a shows a schematic overhead view of an electric mounting box having an insert according to the second embodiment, and

FIG. 4b shows a schematic cross section of the electric mounting box having an insert according to the second embodiment

In the figures, like constructive elements are denoted respectively by like reference numerals.

FIG. 1a shows a cross section of an insert 1 according to the first exemplary embodiment. Insert 1 is provided with a carrier material 2 disposed in the middle. Here, carrier material 2 is a metal mesh. An intumescent layer 4 is respectively disposed on both sides of carrier layer 2. These intumescent layers 4 form an upper side and an underside of insert 1. Since carrier material 2 is a metal mesh, a large number of bonds through mesh openings, not shown, of metal mesh 2 exists between the upper side and the underside. Here, insert 1 is formed as a flat mat 6, which may be individually cut to size or customized by a user.

In FIG. 1b, a cross section is shown of insert 1 according to a second exemplary embodiment. In this case, carrier material 2 of insert 1 is equipped with an intumescent layer 4 only on one side. According to the exemplary embodiment, carrier material 2 is a metal sheet. As an example, intumescent layer 4 was applied on carrier material 2 and cured by an injection-molding process.

FIG. 2a shows a schematic overhead view of a mat 6 for cutting out at least one insert 1 according to a first embodiment. Mat 6 has a square base area and has been prepared for individual cutting to size. For example, mat 6 may be customized with scissors in such a way that several inserts 1 can be cut out of mat 6. Due to this type of configuration of the insert, no special shape is predetermined for the final insert 1. In this case, insert 1 may be individually configured and cut to size by a user.

In FIG. 2b, a schematic overhead view is illustrated of a mat 6 having a multiplicity of inserts 1 according to a second embodiment. In this case, mat 6 has a rectangular base area and has been perforated during manufacture. Here, six identically shaped inserts 1 can be cut out of mat 6 by virtue of several perforations 8. According to the exemplary embodiment, inserts 1 have the shape of a cross. After inserts 1 have been cut out, a residue 10 of mat 6 is left. An insert 1 may consist of several smaller individual parts, which may be formed, for example, from residue 10 of mat 6.

FIG. 3 shows a schematic overhead view of an insert 1 according to the second embodiment, wherein the insert has been separated from the other inserts of mat 6.

In the overhead view, insert 1 has the shape of a cross and has been removed from mat 6 of FIG. 2b. Insert 1 has a central region 12, from which four arms 14 extend. At their ends, arms 14 respectively have a side rim 16, which is constructed as an overlap region 16, which is able to compensate for fabrication tolerances and serves as an additional seal.

In FIG. 4a, a schematic overhead view is shown of an electric mounting box 20 having an insert 1 according to the second embodiment. Electric mounting box 20 is constructed cylindrically and has four threaded regions 21 for receiving screws. Electric mounting box 20 has an inner region 22, bounded by a rim 24 of the electric mounting box 20, for receiving components and cables, not shown.

An insert 1 according to the second embodiment shown in FIG. 3 is inserted into electric mounting box 20. For this purpose, arms 14 of insert 1 are bent over by 90°. Insert 1 is positioned in electric mounting box 20 in such a way that central region 12 of insert 1 rests on a bottom 26 of electric mounting box 20. Because they are bent over, arms 14 preferably run parallel to wall 24 of electric mounting box 20.

The respective overlap regions 16 of arms 14 project out of electric mounting box 20 and are likewise bent at a 90° angle in such a way that rim 24 of electric mounting box 20 is concealed by overlap regions 16, at least in regions.

Into the inner region 22, protected from fire by insert 1, of electric mounting box 20, it is possible to lead cables between arms 14 of insert 1. This is additionally indicated by the arrows. Alternatively or additionally, slits or openings for routing cables may be made in insert 1.

FIG. 4b shows a schematic cross section of electric mounting box 20 from FIG. 4a along line A-A. The figure illustrates in particular insert 1 in the condition inserted in the inner region 22 of electric mounting box 20. Arms 14 run parallel to wall 24 of electric mounting box 20 and, in overlap region 16, project out of electric mounting box 20. Overlap regions 16 are respectively bent at a 90° angle relative to wall 24 of electric mounting box 20 and thus run parallel to a wall 32, which according to the exemplary embodiment is a cavity wall 32.

A cover 28 is able to seal electric mounting box 20 and clamp the protruding overlap regions 16 of insert 1 between cover 28 and wall 24 of electric mounting box 20. As an example, cover 28 may form an interlocking joint with wall 24 of electric mounting box 20 via snap-in noses 30. Hereby not only electric mounting box 20 but also possible gaps between electric mounting box 20 and wall 32 are sealed at least in regions. By analogy with the preceding figure, the arrows show options for routing cables into electric mounting box 20.

1: An insert as fire protection of at least one electric mounting box, said insert comprising:
a carrier material, and
at least one intumescent layer,
wherein the carrier material and the intumescent layer are plastically deformable.

2: The insert according to claim 1, wherein the carrier material comprises a metal.

3: The insert according to claim 2, wherein the carrier material is a metal foil or a metal sheet.

4: The insert according to claim 2, wherein the carrier material is a metal mesh or a metal fabric.

5: The insert according to claim 1, wherein the intumescent layer is applied on one side of the carrier material.

6: The insert according to claim 1, wherein the intumescent layer is situated on both sides of the carrier material.

7: The insert according to claim 1, having a thickness of less than 4 mm.

8: The insert according to claim 1, having two arms situated opposite one another, so that they can be introduced interlockingly into a rectangularly shaped or round electric mounting box.

9: The insert according to claim 8, wherein the length of the arms is greater than the depth of the electric mounting box.

10: A method for manufacturing an insert according to claim 1, said method comprising:
supplying a plastically deformable carrier material,
applying at least one intumescent layer at least in a region on the supplied carrier material,
solidifying the applied intumescent layer.

11: The method according to claim 10, wherein the carrier material is supplied in pre-customized form.

12: The method according to claim 10, wherein the insert is subsequently customized.

13: An electric mounting box having a plastically deformable insert according to claim 1, manufactured by a method comprising:
supplying a plastically deformable carrier material,
applying at least one intumescent layer at least in a region on the supplied carrier material,
solidifying the applied intumescent layer,
wherein the insert extends along the walls of the electric mounting box to its inside.
